(19) United States
(12) Patent Application Publication
(10) Pub. No.: US 2005/0057533 A1
(43) Pub. Date: Mar. 17, 2005

(54) Detecting stylus location using single linear image sensor

(76) Inventor: Yong Liu, Herndon, VA (US)

Correspondence Address: Yong Liu, 13406 Elliott An Court, Herndon, VA, 20171, US

(21) Appl. No.: 10/651,349

(22) Filed: Aug. 28, 2003

(51) Int. Cl. G09G 5/00

(52) U.S. Cl. 345/179

(57) ABSTRACT

An apparatus and method are provided to determine the location of a stylus in an active area of a plane. In one preferred embodiment, the apparatus includes a reflecting device and a detecting device. They are disposed opposite at periphery of the active area. Two images are received by the detecting device. In an alternate embodiment, the apparatus include a reflecting device disposed at a periphery of the active area, a detecting device disposed underneath the plane, and two reflecting device disposed underneath the plane to ensure two images are received by the detecting device. The detecting device produces a signal indicating the position of the stylus.

### CROSS-REFERENCE TO RELATED APPLICATIONS

Not Applicable

### FEDERALLY SPONSORED REAEARCH

Not Applicable

### SEQUENCE LISTING OR PROGRAM

Not Applicable

### BACKGROUND OF THE INVENTION

1. Field of the Invention

The present invention relates to an apparatus and method of detecting the position of an object in a plane and, more specifically, detecting the position of a stylus on a surface using a single linear camera.

2. Backgroud of the Invention

Technologies of detecting the position of a stylus, or a pen on a plane are widely used in electronic transcription systems or pen input based computer systems. Based on the stylus being used the technologies can be characterized into two categories: (1) the passive digitizer; (2) the active digitizer.

The first category of the technologies, the passive digitizer, is also called the touch sensitive technology. In such a system, the input device or stylus contains no electronics. The touch of the stylus on a digitized screen disturbs the energy field on the screen and the location of the touch is detected by the digitizer based on the change of the energy field. There are five touch sensitive systems: resistive, capacitive, near-field imaging, infrared grid, and acoustic wave.

Resistive systems are comprised of two layers of films separated by insulting spacer dots. Pressing the screen makes the top film contacted with the conductive film beneath. The x, y position of the contact is determined based on the changes in the current flows that are proportional to the distance from the edge.

Capacitive are curved or flat glass overlays. A voltage is applied to the four corners of the screen, creating a uniform electric field on the surface of the screen. The touch of a finger or a conductive stylus draws current from each side in proportion to the distance from the edge. The location of the touch is determined from the change of the voltage along vertical and horizontal directions.

Near-field imaging works similar to a capacitive system. It consists of two laminated glass sheets with a patterned coating of transparent metal oxide between them. An AC signal is applied to the patterned conductive coating, creating an electrostatic field on the surface of the screen. The touch of a finger or a conductive stylus disturbs the electrostatic field and the position of the contact is determined.

Infrared grid is based on a light-beam interruption technology. It uses an array of photodiodes on two adjacent screen edges with corresponding phototransistors on the opposite edges. These diode/detector pairs establish an optical grid across the screen. Any object that touches the screen causes the light-beam breaks along the horizontal and the vertical axes. This then indicates the coordinates of the touch point.

Similar to infrared grid, acoustic wave uses an array of transducer to emit ultrasonic waves along two sides. These waves are reflected across the surface of the screen. When a finger or other energy-absorbed stylus is inserted, it disturbs the pattern. The location of the stylus is determined from the changes in the sound.

The second category of the technologies, or active digitizer, is one in which the input device contains some electronics external to the touched surface of the digitizing system. Devices in this category include light pen, sonic system, electrostatic and electromagnetic digitizer.

A light pen is a stylus-type device that allows users to point and write directly on a display monitor. Light pen uses a photocell that is placed against the surface of a monitor to sense the CRT video-signal-refresh beam while it refreshes the display. The CRT controller directs an electron gun to scan the display screen one line at a time, exciting the phosphor to draw the displayed image. Phosphor glows brightly when an electron beam strikes it and slowly dims after the beam moves on. The photocell in the light pen relies on this behavior to sense when the electron beam is scanning where the light pen is pointing. The CRT controller records the current X, Y position of the electron gun that is controlling when it receives a signal from the light pen that it has sensed the electron beam.

The sonic technology uses sensors placed along the edges or corners of the active writing surface to detect ultrasonic signals that a stylus emits when its tip touches the surface. The position of the stylus is determined based on a time of propagation of ultrasound between the stylus and detectors.

Electrostatic devices have a writing surface made by bonding a thin conductive film to a sheet of glass. A stylus tethered to the device emits a high-frequency signal that is picked up by the conductive film. The electrostatic changes are measured to determine the X and Y coordinates of the location of the stylus

Electromagnetic technology works in the similar way as electrostatic. The stylus transmits an electronic field of low frequency that acts on a grid of wires under the writing surface. The position of the stylus is determined by polling the horizontal and vertical lines for the strongest signal. A variation to this technology is that the stylus does not actively emit signals. In operation, the grid of wires under the sensor board alternates between transmit and receive modes in about every 20 microseconds. In the transmit mode, the signal emitted stimulates oscillation in a coil-and-capacitor resonant circuit in the stylus. In the receive mode, the energy of the resonant circuit oscillations in the stylus is detected by the sensor's antenna grid. The coordinates of the stylus position is determined in response to the voltage induced in the respective wires.

All technologies discussed above require that either the drawing surface must be electronically digitized or the stylus must be electronically equipped in order to detect the stylus location.

Advances in the technology of detecting a stylus location are disclosed in U.S. Pat. No. 5,484,966, “Sensing Stylus Position Using Single 1-D Image Sensor” issued in Jan. 16, 1996 to Jakub Segen. The patent consists of one single image sensor and two mirrors. As a stylus is inserted into a drawing surface, four images are received by the image sensor. From each image is determined a light path coming from the stylus. The point where the stylus is inserted is the intersection of the four light paths.

The patent has numerous advantages over its prior arts. However a number of disadvantages exist as will be seen from a brief discussion provided below.

Referring to FIG. 1, the invention includes two mirrors 102, 104; they form an angle that is less than one-hundred eighty degree and are disposed substantially perpendicular to the viewing plane 116. Included is also a linear image sensor 110 that is positioned opposite to the angle formed by mirrors 102, 104. As stylus 108 being placed into active area 106 of the viewing plane 116, four images are received by the sensor 110; they are the directive image via path PD, two single reflective images via paths PR1, PR2 and one double reflective image via path PRR. When an image is traced back from the sensing device 110 towards the stylus 108, it determines a straight line that contains the point that represents the position of the stylus 108. The intersection of such four straight lines gives the position of the stylus 108 on the viewing plane 116. In other word, the X, Y coordinates of the stylus on the viewing plane 116 is the solution of a linear system having four equations and two unknowns. This is the situation termed as an overdetermined system of linear equations.

Solving an overdertermined system can result in large errors. Traditionally such problems are solved by error minimization.

The prior art showed by FIG. 1 disclosed a method on how to use the single reflection images, i.e., the first reflection image whose path is PR1 and the second reflection image whose path is PR2 to determine the position of the stylus 108 in the active area 106. The method includes a criterion to distinguish the single reflection images from other images. However, large errors may result when using the two single reflection images to determine the stylus position without looking for the third or forth image. As illustrated by FIG. 2, two light paths traced back from the two single reflection images of the stylus 108 are merged into a straight line L. It is impossible to locate points near the line L based on their single reflection images. To minimize such errors, the trace of the other images, i.e., the direct image trace PD and the double reflected image trace PRR must be determined. However, there is a technical difficulty to determine which image is the double reflected image.

In the prior art, a technique is introduced to locate the double reflected image by determining the order of the reflections, that is, which mirror 102, 104 a light leaving the stylus 108 first contacts. However, a significant error may still be resulted when the stylus appears near the diagonal axis 114 so that the double reflected image will merge with the direct image and the two images appear as only one blurred image in the sensing device 110. Another technique introduced in the priori art for identifying the double reflected image is to create two scenarios, each being an overdetermined system of four linear equations with two unknowns. The equations for each scenario are solved and the stylus position is selected as the solution whose associated error is smaller.

To overcome the problems brought out by four images, the prior art also introduces some techniques to reduce the number of images the sensing device 110 receives. It suggests to place a polarizing filter over each mirror to eliminate the double reflected image. But the sensing device 110 still receives three images and the problem to have an overdetermined system is not solved.

The present invention overcomes all disadvantages resulted from the prior art; it eliminates all unnecessary images without using polarizing filters, and achieves an optimum result. In one preferred embodiment, there is included one sensing device and one reflection device. The sensing device receives two and only two images of the stylus. Such a result not only reduces the complexity made by the prior art, but also increases the accuracy of determining the position of the stylus.

### SUMMARY OF THE INVENTION

The present invention provides an apparatus and method for determining the position of an object in an active area of a plane. In one preferred embodiment, the apparatus includes one reflecting device and one detecting device. The reflecting device is positioned perpendicular to the plane at a periphery of the active area. It receives an image of the object from the active area and reflects the image back toward the active area parallel to the plane. The detecting device is positioned in the plane at a periphery of the active area opposite the reflecting device. It receives an image directly from the object on the active area and the image reflected from the reflecting device. Each image determines a light path coming from the object. The position of the object on the plane is the point where the two light paths intersect. In an alternate embodiment, the apparatus has a first reflecting device disposed on a viewing plane at a periphery of the active area. A detecting device is positioned on the reverse of the viewing plane. A second reflecting device is disposed parallel to the first reflecting device on the reverse of the viewing plane, and a third reflecting device positioned beneath the viewing plane, forming a 90 degree with the second reflecting device. The sensing device receives two and only two images of the stylus.

### BRIEF DESCRIPTION OF THE DRAWINGS

FIG. 1 is a plane view diagram illustrating the operation of a preferred embodiment of the prior art.

FIG. 2 is the plane view diagram illustrating a degenerated case of the prior art.

FIG. 3 is a plane view diagram illustrating the operation of one preferred embodiment of the present invention.

FIG. 4 is a cross-sectional view diagram illustrating the operation of the preferred embodiment of the present invention.

FIG. 5 shows the diagram of determining the equation of a light path via its reflected light ray in the present invention.

FIG. 6 is a top plane view of an alternate embodiment of the present invention.

FIG. 7 is a cross sectional view of the alternate embodiment of the present invention.

FIG. 8 is a reverse side view of the alternate embodiment of present invention.

FIG. 9 is a diagram illustrating the operation of the alternate embodiment of the present invention.

### DETAILED DESCIPTION

The present invention relates to an apparatus and method for detecting the position of a stylus on a two-dimensional plane using a one-dimensional sensing device. In one preferred embodiment, the apparatus includes one reflecting device. The sensing device receives two images of the stylus, one is directly from the stylus and one is reflected from the reflecting device. The two images determine two non parallel light paths coming from the stylus. The intersection of the two light paths is the position of the stylus on the plane.

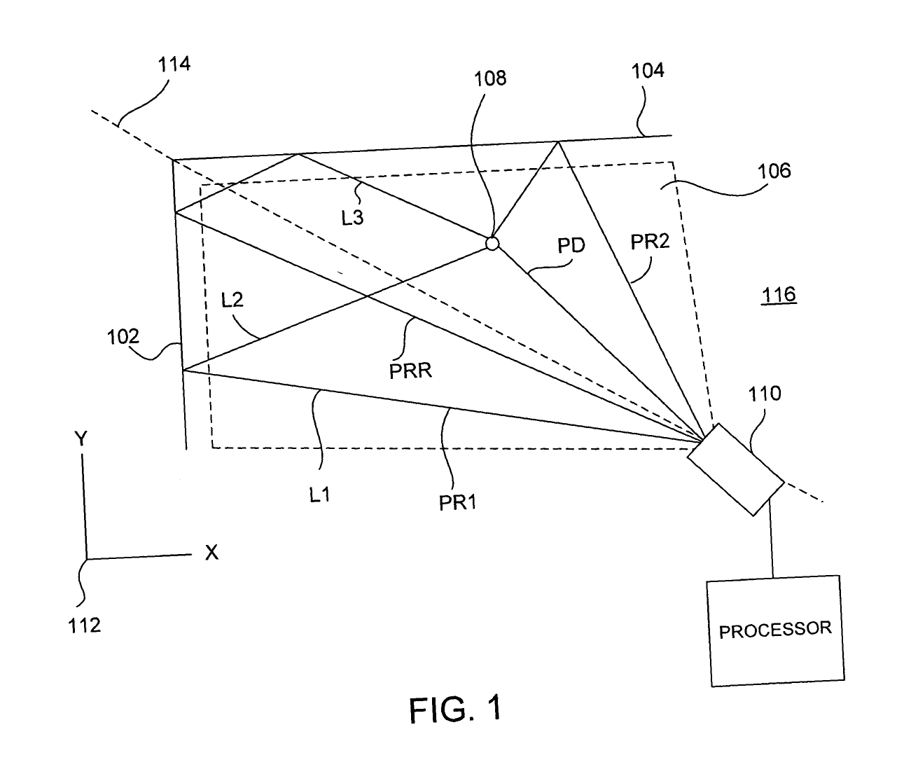

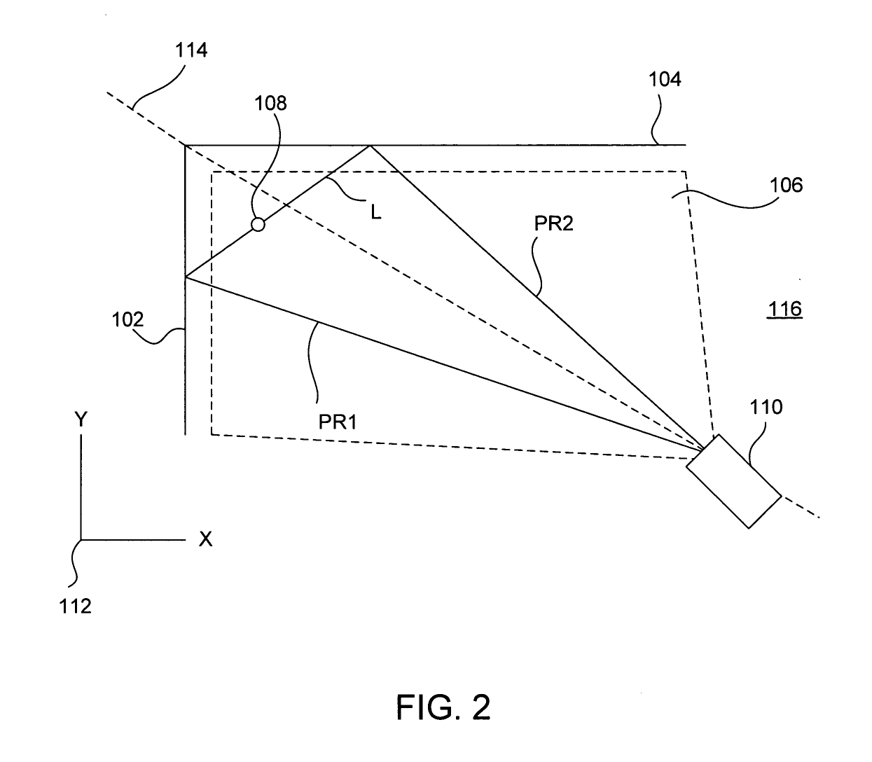

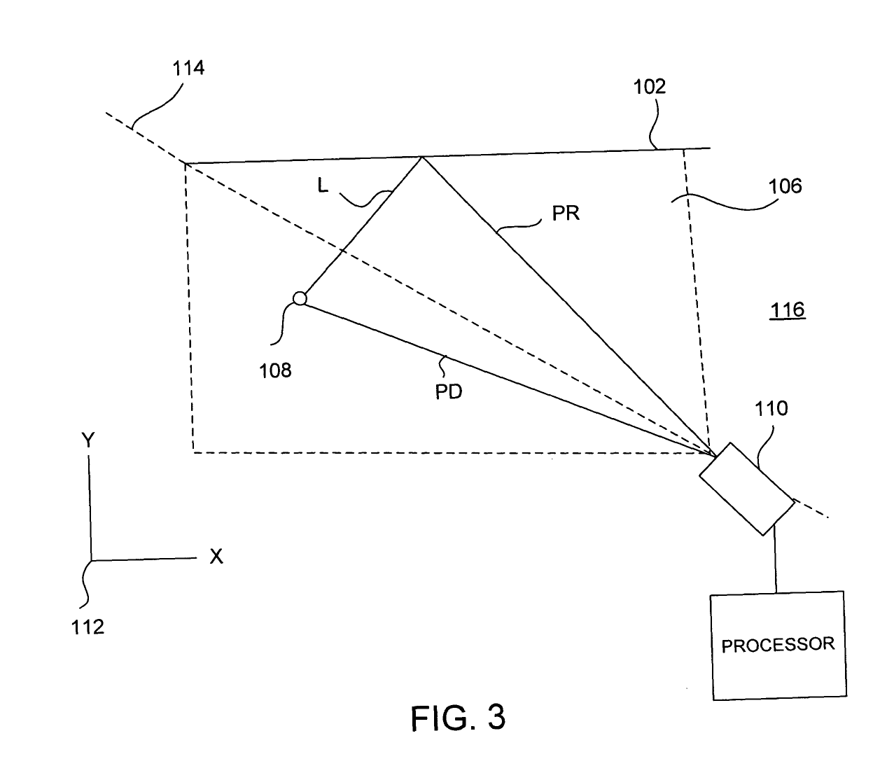

Starting with FIG. 3, the diagram illustrates one embodiment of the system according to the present invention. Reference numbers are adapted from FIG. 1 for showing the difference and similarity between the prior art and the present invention. As illustrated, the invention includes one reflecting device 102, and one sensing device 110. An X, Y coordinate system is referenced at the origin 112. A viewing plane 116 is defined by the drawing sheet of FIG. 3. An active area 106 of the system is a bounded area within the viewing plane 116. As stylus 108 is placed into the active area 106, two images are received by the sensing device 110.

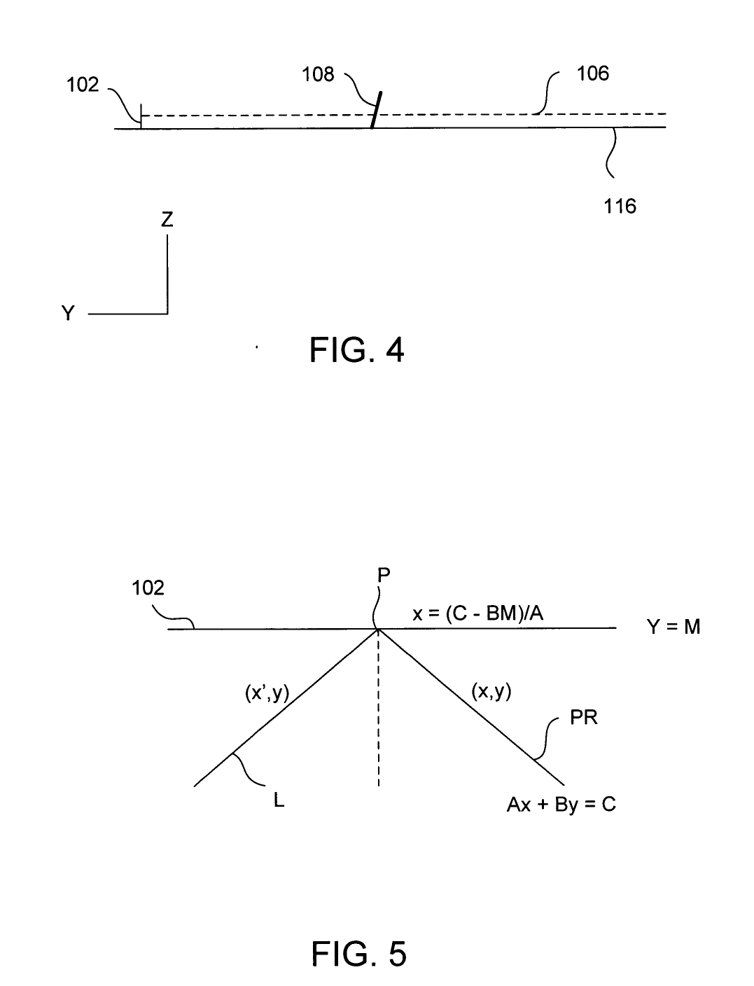

In a preferred embodiment, the reflecting device 102 is a long thin mirror facing the active area 106. The reflective surface of the mirror is substantially flat and can be made of glass coated with a reflecting material. Referring to FIG. 3 and FIG. 4, the mirror 102 is positioned on the viewing plane 116 and its reflecting surface is substantially perpendicular to the viewing plane 116. The mirror 102 is long enough to ensure that all reflections of the stylus 108, once being positioned in the active area 106 reach the sensing device 110. The height of the mirror 102 can be small as long as the sensing device 110 can receive the image of the stylus 108 reflected from the mirror 102.

The sensing device 110 is positioned in the viewing plane 116. In the preferred embodiment, the sensing device is a line-scan camera consisting of an array of light sensing elements that convert optical signals from the stylus into electrical signals. Examples of such devices include a linear charged coupled device (CCD) array and a linear complementary metal oxide semiconductor (CMOS) array. The view angle of the camera is at least 90 degree to ensure that the viewing area of the camera covers the active area 106 within the viewing plane 116. While it will be apparent to persons skilled in the relevant art to construct and operate the sensing device, a discussion is provided below to show the new results of the present invention on how to capture two images of the stylus by a one-dimensional sensor and use them to determine the position of the stylus within the active area.

In the preferred embodiment illustrated by FIG. 3, when a stylus 108 is placed in the active area 106, the image of the stylus 108 can enter the sensing device 110 via two distinct paths. The first path, referenced by PD represents the path for light that comes from the stylus 108 and enters directly the sensing device 110; this is termed the direct image. The second path is represented by PR for light coming from the stylus 108, reflecting off the mirror 102 and entering the sensing device 110; this is termed reflected image.

When the sensing device 110 receives images, it transforms them into an N-dimensional vector of digital electrical signals, where N is the number of pixels of the linear CCD or CMOS sensor. A processor receives the vector of signals from the sensing device 110 and compares the vector values with a threshold value to distinguish “white” pixels and “black” pixels. All “white” pixels are collected into regions of continuous chain of white pixels. The length of such a region is the number of pixels in the region. A highlight is such a region that is longer than a threshold value that depends on the resolution of the sensing device 110. Regions that are smaller than the threshold are eliminated. The position of a highlight in the 1-D image is computed with sub-pixel accuracy to a value represented as a rational number ranging from 1 to N. The detailed process of determining a highlight point is apparent to one skilled in the relevant art.

In order to calculate the stylus position, a Cartesian coordinate system is chosen to represent the plane of the active area 106. The origin of the coordinate system is identified by reference number 112. The positive x-axis is parallel to the mirror 102 and extends toward the right. The positive y-axis extends upwards. Under the coordinate system, the equation for the mirror 102 is given as
y=M [1]
where M is a constant.

As FIG. 3 illustrated, the position of the stylus 108 is the intersection of light ray PD and L. The light ray L is reflected off the mirror 102 and enters the sensing device 110 via light ray PR. As discussed above, each of light ray PD and PR is represented by a highlight point in an 1-D image, ranging from 1 to N. If the position P of the stylus in the active area 106 is a point on the viewing plane 116 with coordinate x and y, then the image of P is given as a highlight point u between 1 and N. The relationship between x, y and u is given by Equation [2]
ax+by+c=(dx+ey+1)u [2]
where a, b, c, d, and e are calibration parameters of the sensing device 110, which are assumed to be constant. The procedures to determine these parameters are apparent to one skilled in the relevant arts and can be found in the reference described in the book, O. D. Faugeras, Three-Dimensional Computer Vision, MIT Press, Cambridge, Mass., 1992.

Relationship between x, y and u can also be non-linear if a lens is present in the sensing device 110 since lenses distort the highlight position in the one-dimensional image. Such a relationship may be represented by replacing u in Equation [2] with a non-linear lens distortion function f(u). The following discussion is based on Equation [2]. The same analysis applies to the non-linear version of Equation [2] where u is replaced by f(u).

For a given value of u, Equation [2] can be written to represent a light ray enters the sensing device 110:
Ax+By=C [3]
where
A=a−du;
B=b−eu; and
C=u−c.

Let u and v be the two highlight points derived from the two images received by the sensing device 110 through light ray PD or PR respectively. Then Equation [3] represents the light ray having the highlight point u, and the equation for the light ray having the highlight point v is given by
Dx+Ey=F [4]
where
D=a−dv;
E=b−ev; and
F=v−c
   Since light ray PD is always under below the light ray PR, the condition
   |A/B|>|D/E| [5]
   can be evaluated to determine which light ray is for the reflected image, i.e, the light ray PR. Assume that Condition [5] is true then Equation [3] represents the light ray PR. Through Reflection Principle, the light ray L can be determined by Equation [1] and Equation [3]. The process goes as follows.

The light ray reflects off the mirror 102 at the point where light ray PR and the mirror 102 intersect:
y=M; and [6]
x=(C−BM)/A [7]
where A is never be zero in the active area 106 since light ray PR never be horizontal.

FIG. 5 illustrates how the equation for light ray L is derived from Equation [1] representing the mirror 102 and Equation [3] representing light ray PR. Reference character P indicates the reflection point given by Equation [6] and [7]. By the principle of light reflection, a point (x, y) on light ray PR has the corresponding point of (x′, y) where x′ is the image of x respect to the normal represented by Equation [7] and can be given as
x′=2(C−BM)/A−x [8]
It can be determined that the equation for L is given as
−Ax+By=2BM−C [9]

Utilize Equation [4] for the direct image path PD and Equation [9] for the reflected image path L, the position of the stylus 108 on the active area 106 can be precisely determined.

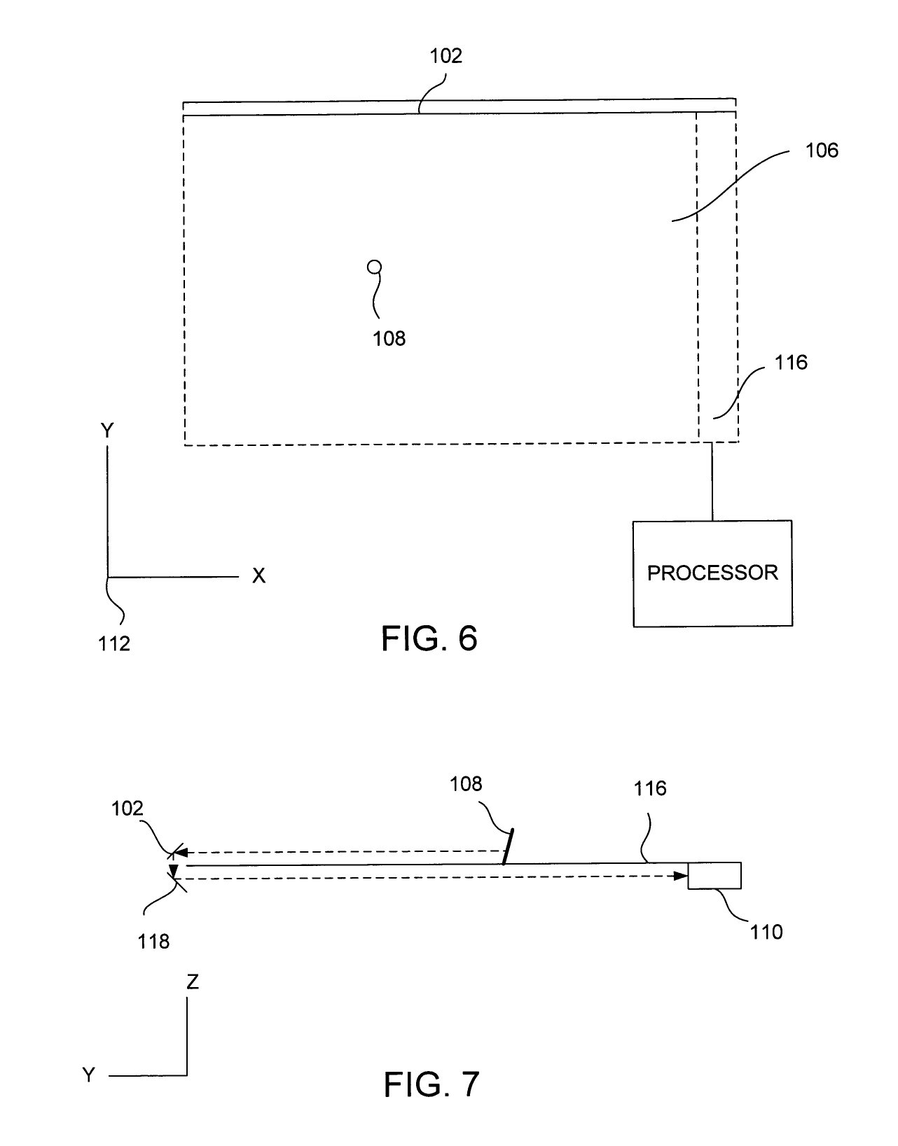

An alternate embodiment of the present invention is illustrated via different views by FIGS. 6, 7 and 8. The embodiment includes one mirror facing to an active area and a sensing device positioned behind the viewing plane. Other two mirrors are disposed behind the viewing plane to ensure that two and only two images are received by the sensing device. The embodiment is particular useful if the invention is applied to a drawing application where a user may position a hand on the drawing surface. As illustrated by FIG. 6, the viewing plane 116 is a bounded region on the drawing sheet of the figure. The mirror 102 is positioned at a periphery of the viewing plane 116. The stylus 108 is placed within the active area 106 of the viewing plane 116.

FIG. 7 is the side view of the embodiment. As illustrated, there is an angle of substantial 45 degree between the reflecting surface of the mirror 102 and the viewing plane 116. The mirror 118 is positioned below the mirror 102. They form a substantial 90 degree between their reflecting surfaces. The sensing device 110 is attached on the reverse side of the viewing plane 116, opposite the mirror 118.

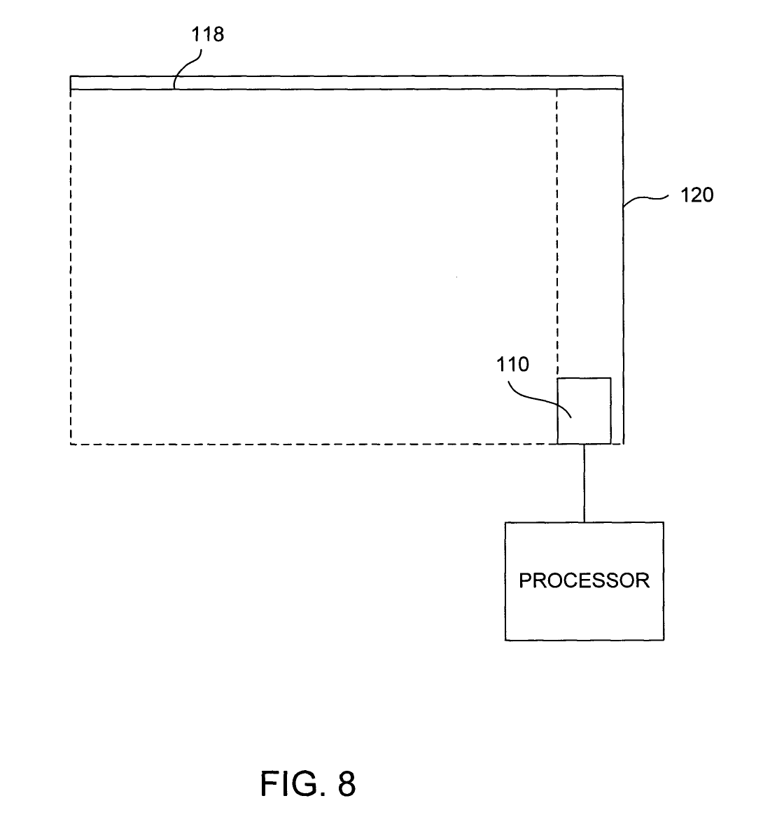

FIG. 8 is the backside view of the embodiment. Mirror 120 is positioned perpendicular at a periphery of the reverse of the viewing plane 116. The angle between mirror 118 and mirror 120 is no more than 90 degree. The sensing device 110 is disposed at a periphery of the reverse of the viewing plane 116, close to the mirror 120 to ensure that two images are received when the stylus 108 is positioned on the active area 106.

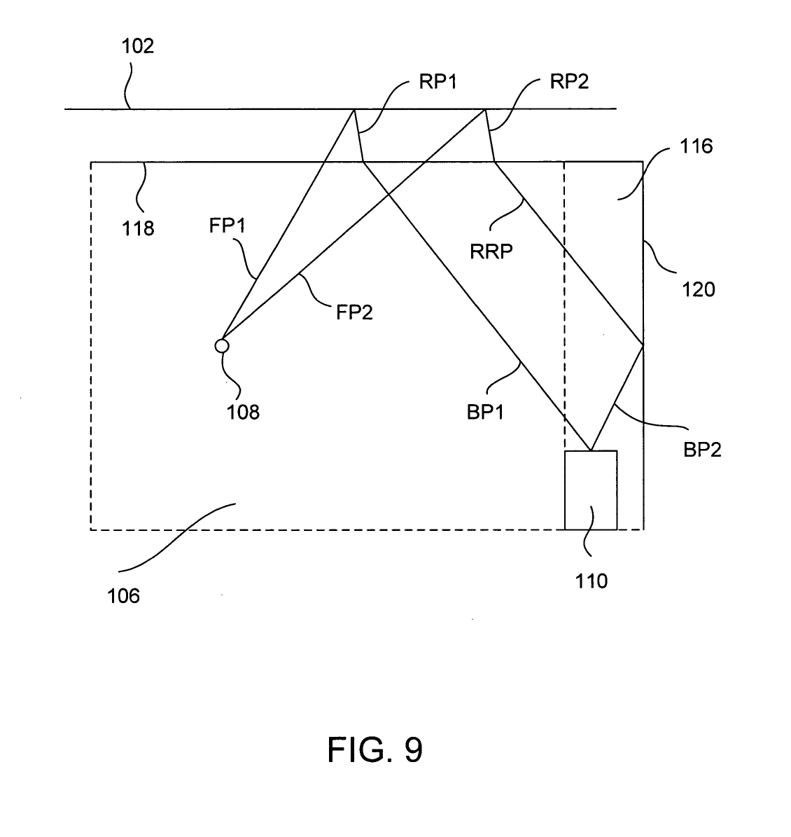

FIG. 9 is the diagram illustrating the operation of the embodiment. An X, Y, Z coordinate system is referenced at the origin 112 so that the viewing plane 116 is in the X-Y plane. The positive x-axis is parallel to the mirror 102 and extends toward the right. The positive y-axis extends upwards and the positive z-axis points outwards the drawing sheet. As the stylus 108 is inserted into the active area 106, two images are received by the sensing device 110. The first image enters the sensing device 110 through path FP1, RP1, and BP1. The light ray RP1 is the reflection of the light ray FP1 via the mirror 102, and the light ray BP1 is the reflection of the light ray RP1 via the mirror 118. The second image enters the sensing device 110 through path FP2, RP2, RRP and BP2. The light ray RP2 is the reflection of light ray FP2 via the mirror 102; the light ray RRP is the reflection of light ray RP2 via the mirror 118; and the light ray BP2 is the reflection of the light ray RRP via the mirror 120. To determine the position of the stylus, it suffices to derive equations for path FP1 and FP2. The intersection of the two paths is the position of the stylus.

As discussed above, each image received by the sensing device determines a light ray represented by equation [3] or [4] and Z=−h. The condition
AB<0 [10]
is evaluated to determined if the equation is for light ray BP2. If this is the case, then the equation [3] and Z=−h can be combined with the equation for mirror 120 to determine the equation for light ray RRP, where an equation for a mirror is a plane in X-Y-Z space:
aX+bY+cZ+d=0 [11]
Similarly, the equation for light ray RRP can be combined with the equation for mirror 118 to determine the equation for light ray RP2, and equation for light ray RP2 can be combined with the equation for mirror 102 to determine the equation for light ray FP2. By the same procedures, the equation for light ray BP1 can be combined with the equation for mirror 118 to determine the light ray RP1 and the equation for light ray RP1 can be combined with the equation for mirror 102 to determine the equation for light ray FP1.

The stylus used in the present invention can be either passive or active. A passive stylus includes, but not limited to pens, finger, and other objects without electronics or light sources. An active stylus may include electronics and light sources.

An additional embodiment of the present invention employs an active stylus that is equipped with a pressure sensor that relates light source intensity to the stylus pressure on the active plane.

The stylus location system of the present invention may be used in a wide variety of situations. The system may be used for screen control applications such as selecting an icon or entering a command. In addition, the system may be used for graphical data capture such as drawing pictures. Furthermore, the system may be used for recording hand written notes, recording a signature, and for handwriting recognition.

The present invention has numerous advantages over the prior arts. It not only optimizes the physical features and process outcomes of the prior arts, but also facilitates a more accurate determination of the x, y location of the stylus.

Although the description above contains many specifications, these should not be construed as limiting the scope of the invention but as merely providing illustrations of some of the presently preferred embodiments of this invention. Thus the scope of the invention should be determined by the appended claims and their legal equivalents, rather than by the examples given.

1. An apparatus for determining the location of an object in an active area of a plane, comprising:
reflecting means, disposed substantially perpendicular to said plane at the periphery of the active area, for receiving a first image of the object from the active area and for reflecting said first image back toward the active area substantially parallel to said plane; and
detecting means, disposed in said plane at a periphery of the active area opposite the reflecting means, for receiving said first image and a second image and for producing a signal indicating the position of said first and second images.

2. A method for determining the location of an object in an active area of a plane, comprising:
reflecting a first image of the object back into the active area substantially parallel to said plane, from a reflecting means located at a periphery of the active area; and
receiving said first image from said reflecting means and a second image from the object at a detecting means located at a periphery of the active area; and
determining the position of the object in said plane from said first image and said second image received at said detecting means.

3. An apparatus for determining the location of an object in an active area of a plane, comprising:
first reflecting means, disposed substantially in 45 degree to the plane at a periphery of the active area, for receiving a first image of the object from the active area and for reflecting said first image downwards the reverse of said plane, for receiving a second images of the object from the active area and for reflecting said second image downwards the reverse of said plane; and
second reflecting means, disposed under said first reflecting means, substantially aligned with said first reflecting means, having the reflecting surface disposed at an angle which is substantially ninety degree to said first reflecting means, for receiving said first and second images from said first reflecting means, for reflecting said first and second images toward the reverse of said plane, substantially parallel to said plane; and
third reflecting means, disposed beneath said plane, substantially perpendicular to the reverse of said plane, disposed at a periphery of the reverse of said plane, disposed at an angle which is substantially ninety degree to said second reflecting means, for receiving said second image and for reflecting said second image back toward the reverse of said plane, substantially parallel to said plane; and
detecting means, disposed beneath said plane, opposite said second reflecting means, for receiving said first and second images and for producing a signal indicating the position of said first and second images.

4. A method for determining the location of an object in an active area of a plane, comprising:
reflecting a first image of the object downwards reverse of said plane, from a first reflecting means located at a periphery of the active area; and
reflecting a second image of the object downwards the reverse of said plane, from said first reflecting means; and
receiving said first image from a second reflecting means and said second image from a third reflecting means at a detecting means positioned on the reverse of said plane; and
determining the position of the object in said plane from said first image and said second image received at said detecting means.
